(19) United States
(12) Patent Application Publication
(10) Pub. No.: US 2015/0298939 A1
(43) Pub. Date: Oct. 22, 2015

(54) ELEVATOR

(71) Applicant: Riku LAMPINEN, Helsinki (FI)

(72) Inventor: Riku LAMPINEN, Helsinki (FI)

(73) Assignee: KONE CORPORATION, Helsinki (FI)

(21) Appl. No.: 14/665,858

(22) Filed: Mar. 23, 2015

(30) Foreign Application Priority Data
Apr. 16, 2014 (EP) 14164857.6

(51) Int. Cl. B66B 7/06

(52) U.S. Cl. CPC B66B 7/068

(57) ABSTRACT

An elevator comprising
a hoistway;
an elevator car vertically movable in the hoistway;
a counterweight vertically movable in the hoistway;
at least one tightening wheel located in the lower end of the hoistway;
at least one rope wheel located in or at least in proximity of the upper end of the hoistway;
a first roping interconnecting the car and counterweight and passing around the at least one rope wheel located in or at least in proximity of the upper end of the hoistway;
a second roping interconnecting the car and counterweight and passing around the at least one tightening wheel, the tightening wheel being mounted movably back and forth in a first direction towards the second roping, and in a second direction away from the second roping; and
means for exerting force on the tightening wheel to move it in the first direction so as to tighten the second roping.

The elevator further comprises means for limiting the movement speed of the tightening wheel towards the first direction and the second direction.

This application claims priority to European Patent Application No. EP14164857.6 filed on Apr. 16, 2014, the entire contents of which are incorporated herein by reference.

### FIELD OF THE INVENTION

The invention relates to an elevator. The elevator is particularly meant for transporting passengers and/or goods.

### BACKGROUND OF THE INVENTION

Elevators typically have a suspension roping between the elevator car and the counterweight which roping passes around a rope wheel mounted stationary in some suitable position above said elevator units. Additionally, the elevator may need to be provided with a second roping between the elevator car and the counterweight suspended to hang from the elevator car and the counterweight. This type of arrangement is normally used to provide compensation for the weight of the hoisting roping. Particularly, in this way the unbalance caused by the hoisting roping and occurring when the elevator car is run to its extreme position can be eliminated. The second roping can additionally or alternatively be used to provide a tie-down-function (also known as lock-down function). The second roping is generally tensioned to pass around a rope wheel mounted stationary in some suitable position below said elevator units, for instance in the lower end of the hoistway.

When an elevator car is parked at landing to unload and load, people tend to move within the car and between the car and the landing such that car load is uncontrollably changed. In particular, in these situations people are generally free to exit and enter the elevator car as they wish. In these situations more or less sudden vertical forces, often affecting the car in an impact-like manner, are exerted randomly on the elevator car. Correspondingly, sudden lightening of the load causes sudden changes in vertical forces exerted on the car.

Unless prevented, the sudden changes in vertical forces are likely to cause rapid stepwise movement of the car upwards or downwards, or even vertical swinging of the car. A drawback of the known elevators has been that this kind of rapid movement of the car caused during the loading and unloading has been difficult to eliminate simply and efficiently.

The second roping may be furthermore tensioned with a tensioning means, such as a tensioning weight. In a sudden increase of car load, the car is displaced downwards whereby the second roping is momentarily loosened. The tightening arrangement rapidly returns the higher tension level back to the second roping, whereby it urges the car to the same direction as the increased load.

The tie-down function, referred to above, is usually obtained by arranging the second roping to pass around a rope wheel. Considerable rising of the rope wheel in a case where the counterweight (or the car) accidentally comes to a sudden stop during a run of the elevator, is blocked and therefore the rope wheel can produce a support force for the loop of the second roping so it restricts the elevator car (or counterweight, respectively) from continuing its upwards directed movement, i.e. so called jumping is prevented. Such a sudden stop may be caused for example if during a run of the elevator the counterweight accidentally gets stuck on its guide rails or if the safety gear is activated, e.g. due to overspeed situation. These types of incidents would be harmful and dangerous, because they would cause sudden jerks for the people inside the car. One sort of a tie-down arrangement is disclosed in U.S. Pat. No. 2,270,441 A, for instance. The known tie-down devices generally react to extremely large one-directional shocks caused in the elevator roping system during an emergency, and they are not designed solve the problems of the loading and unloading situations. In particular, they are not suitable to act as means for removing up and down-directed fine-scale jerks caused in the car during a normal situation, when an elevator car is parked at landing for unloading and/or loading.

### BRIEF DESCRIPTION OF THE INVENTION

The object of the invention is, inter alia, to solve previously described drawbacks of known solutions and problems discussed later in the description of the invention. The object of the invention is to introduce a new elevator which is improved in terms of its movement during loading and unloading of its car. Embodiments are presented, inter alia, where movement of the car during loading and unloading is reduced by controlling movement of the tightening wheel located in the lower end of the hoistway around which the second roping interconnecting the car and counterweight passes.

It is brought forward a new elevator, which comprises a hoistway, an elevator car vertically movable in the hoistway, a counterweight vertically movable in the hoistway and at least one tightening wheel located in the lower end of the hoistway. The elevator further comprises at least one rope wheel located in or at least in proximity of the upper end of the hoistway and a first roping interconnecting the car and counterweight and passing around the at least one rope wheel located in or at least in proximity of the upper end of the hoistway, and suspending the car and counterweight on opposite sides of said rope wheel. The elevator further comprises a second roping interconnecting the car and counterweight and passing around the at least one tightening wheel, the tightening wheel being mounted movably back and forth in a first direction towards the second roping, and in a second direction away from the second roping; and means for exerting force on the tightening wheel to move it in the first direction so as to tighten the second roping. The elevator further comprises means for limiting the movement speed of the tightening wheel towards the first direction and the second direction. Thereby said means are configured to allow movement of the tightening wheel towards the first direction with a limited speed as well as to allow movement of the tightening wheel towards the second direction with a limited speed. Said means thereby limit the movement speed of the tightening wheel towards the first and second direction without blocking movement towards these directions totally. As a consequence of limiting the movement speed of the tightening wheel towards the first direction, the risks of sudden movement of the car during a loading situation are substantially eliminated. A substantial part of the effects of the sudden increase in car load can thus be neutralized. Particularly a sudden stepwise sag of the car is thus eliminated. As a consequence of limiting the movement speed of the tightening wheel towards the second direction, on the other hand, the risks of sudden movement of the car during an unloading situation are substantially eliminated. A substantial part of the effects of the sudden increase in car load can thus be neutralized. Particularly a sudden stepwise lift of the car is thus eliminated. The slow response in movement (towards both of the two directions) facilitated by said limiting of the speed of the tightening wheel results in that undesired car movement can be neutralized in both of these directions, but also in that the tightening wheel can move slowly towards either one of the first direction and second direction, as optimal for the situation, such that tension in the second roping is maintained appropriate.

In a preferred embodiment said means for limiting the movement speed of the tightening wheel comprise a frame mounted in the hoistway and a hydraulic cylinder containing hydraulic fluid and being mounted between the frame and the tightening wheel, one of its piston part and cylinder part being attached to the frame, and the other of its piston part and cylinder part being attached to the tightening wheel, movement of the tightening wheel in said first direction being configured to cause a stroke of the hydraulic cylinder wherein the piston moves in the cylinder part in a first stroke direction, and movement of the tightening wheel in said second direction being configured to cause a stroke of the hydraulic cylinder wherein the piston moves in the cylinder part in a second stroke direction, and in that said means for limiting the movement speed comprise means for limiting stroke speed of the cylinder in the first and second stroke direction. One benefit of the disclosed system is that it can simply provide the function of reducing car movement during loading and unloading without electrical devices. A further benefit of the disclosed system is that it can work continuously, meaning that hydraulic pressure can keep stabilizing all the time reacting to changes in tension force of the second roping. Stabilization speed can be selected by adjusting the flow control valve, i.e. by adjusting the size of the orifice through which hydraulic fluid flows during stroke of the cylinder. The solution described can be used in parallel with other devices such as a lock-down device.

In a preferred embodiment the means for limiting stroke speed of the cylinder comprises a conduit system for allowing passage of hydraulic fluid to and from the hydraulic chamber during strokes of the hydraulic cylinder connected with an opening in the hydraulic chamber delimited by the piston part and the cylinder part, and one or more adjustable flow control valves in the conduit system, and in that each of the stroke in said first direction and the stroke in the second stroke direction is arranged to a change the volume of the hydraulic chamber, and to displace an amount of hydraulic fluid through said opening and through at least one of said adjustable flow control valves, which amount is equal to the amount of change of the volume of the hydraulic chamber during the stroke, the flow rate of hydraulic fluid into (during a stroke in one of the first and second stroke direction) and out of (during a stroke in the other of the first and second stroke direction) the hydraulic chamber through said opening being thereby limited by said at least one adjustable flow control valve. Thereby the stroke speed of the cylinder during each stroke is adjustably limited. With this configuration, the stroke speeds are easy to adjust. The hydraulic system is hereby also simple to dimension, implement and service.

In a preferred embodiment the means for limiting stroke speed of the cylinder comprises a conduit system for allowing passage of hydraulic fluid into (during a stroke in one of the first and second stroke direction) and out from (during a stroke in the other of the first and second stroke direction) hydraulic chamber, connected with an opening in a hydraulic chamber delimited by the piston and the cylinder, and one or more adjustable flow control valves in the conduit system, and in that a stroke in said first stroke direction is arranged to a change the volume of the hydraulic chamber, and to displace an amount of hydraulic fluid through said opening and a first adjustable flow control valve, which amount is equal to the amount of change of the volume of the hydraulic chamber during the stroke, and in that a stroke in said second stroke direction is arranged to a change the volume of the hydraulic chamber, and to displace an amount of hydraulic fluid through said opening and a second adjustable flow control valve, which amount is equal to the amount of change of the volume of the hydraulic chamber during the stroke, the flow rate of hydraulic fluid into (during a stroke in one of the first and second stroke direction) and out of (during a stroke in the other of the first and second stroke direction) the hydraulic chamber through said opening being thereby limited by different adjustable flow control valves. Thereby the stroke speed of the cylinder in each stroke direction is limited individually adjustable.

In a preferred embodiment said means for limiting the stroke speed of said stroke comprise an opening in a hydraulic chamber of the cylinder; a first conduit connected with the opening for allowing passage of the hydraulic fluid to enter the hydraulic chamber during a stroke of the hydraulic cylinder in one of the first and second stroke direction; a second conduit connected with the opening, for allowing passage of the hydraulic fluid to exit the hydraulic chamber during a stroke in the other of the first and second stroke direction; and in the first conduit a one-way valve arranged to allow flow through the first conduit into the hydraulic chamber and to block flow in the opposite direction, and a first adjustable flow control valve delimiting the flow rate of hydraulic fluid into the hydraulic chamber during a stroke of the hydraulic cylinder in said one of the first and second stroke direction; and in the second conduit a one-way valve arranged to allow flow through the second conduit from the hydraulic chamber and to block flow in the opposite direction, and a second adjustable flow control valve delimiting the flow rate of the hydraulic fluid away from the hydraulic chamber during a stroke of the hydraulic cylinder in said other of the first and second stroke direction.

In a preferred embodiment the means for limiting stroke speed of the cylinder comprises a conduit system for allowing passage of hydraulic fluid to or from the hydraulic chamber during said stroke of the hydraulic cylinder connected with an opening in a hydraulic chamber delimited by the piston and the cylinder, and an adjustable flow control valve in the conduit system, and in that each of the stroke in said first direction and the stroke in the second stroke direction is arranged to a change the volume (increase or decrease) of the hydraulic chamber, and to displace an amount of hydraulic fluid through said opening and said adjustable flow control valve, which amount is equal to the amount of change of the volume of the hydraulic chamber during the stroke, the flow rate of hydraulic fluid into the hydraulic chamber during a stroke in one of the first and second stroke direction, and the flow rate of hydraulic fluid into the hydraulic chamber during a stroke in the other of the first and second stroke direction being thereby limited by said (same) flow control valve. Thereby, the stroke speed of the cylinder during each stroke is adjustably limited. The hydraulic system is hereby also simple to implement and service.

In a preferred embodiment said means for limiting the stroke speed of said stroke comprise an opening in the hydraulic chamber of the cylinder; a conduit, connected with the opening, for allowing passage of the hydraulic fluid to enter the hydraulic chamber during a stroke of the hydraulic cylinder in first stroke direction and for allowing passage of the hydraulic fluid to exit the hydraulic chamber during a stroke in the second stroke direction; and in the conduit an adjustable flow control valve delimiting the flow rate of hydraulic fluid into the hydraulic chamber during a stroke of the hydraulic cylinder in one of the first and second stroke direction, and delimiting the flow rate of the hydraulic fluid away from the hydraulic chamber during a stroke of the hydraulic cylinder in the other of the first and second stroke direction.

In a preferred embodiment said hydraulic chamber is a closed space apart from said opening.

In a preferred embodiment said means for exerting force on the tightening wheel are arranged to continuously exert said force on the tightening wheel.

In a preferred embodiment said means for exerting force on the tightening wheel comprise a spring arranged to continuously urge the tightening wheel towards the first direction by its spring force.

In a preferred embodiment said spring is a compression spring arranged to push the tightening wheel towards first direction by its spring force.

In a preferred embodiment said means for exerting force on the tightening wheel to move the tightening wheel towards tightening direction comprise a weight arranged to urge (push or pull) the tightening wheel towards the first direction by its weight.

The frame is preferably mounted in the hoistway immovably relative to the hoistway. Furthermore, it is preferable that the hydraulic cylinder is mounted between the frame and the tightening wheel such that one of the piston and cylinder is attached to the frame immovably relative to the frame at least in the stroke direction of the cylinder and the other is movable relative to the frame and attached on the tightening wheel.

The elevator referred to is preferably, but not necessarily, installed inside a building. The car is preferably arranged to move vertically and serve two or more landings. The car is preferably arranged to respond to calls from landing(s) and/or destination commands from inside the car so as to serve persons on the landing(s) and/or inside the elevator car. Preferably, the car has an interior space suitable for receiving a passenger or passengers.

### BRIEF DESCRIPTION OF THE DRAWINGS

In the following, the present invention will be described in more detail by way of example and with reference to the attached drawings, in which

FIG. 1 illustrates schematically a side view of an elevator according to a preferred embodiment of the invention.

FIGS. 2a and 2b illustrate each an embodiment for the means for limiting the movement speed of the tightening wheel towards the first direction and the second direction.

FIGS. 3a and 3b illustrate each an embodiment for the means for limiting the movement speed of the tightening wheel towards the first direction and the second direction.

FIG. 4 illustrates preferred details for the means for exerting force on the tightening wheel to move it in the first direction so as to tighten a roping of the elevator.

### DETAILED DESCRIPTION

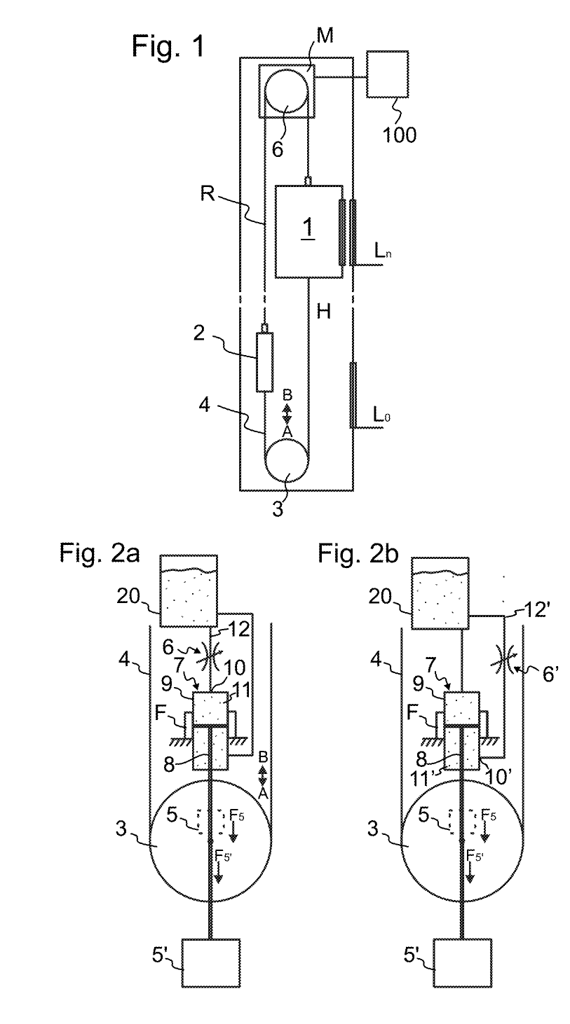

FIG. 1 illustrates an elevator according to a preferred embodiment. The elevator comprises a hoistway H, an elevator car 1 and a counterweight 2 vertically movable in the hoistway H, and a drive machine M, which provides moving force for the elevator car 1 under control of an elevator control system 100. The elevator furthermore comprises landings L₀-Lₙ, where the elevator car is arranged to visit for unloading passengers and/or loading passengers.

The car 1 and counterweight 2 are interconnected by a first roping R, i.e. a suspension roping R, which passes around at least one rope wheel 6 located in or at least in proximity of the upper end of the hoistway H suspending the car 1 and counterweight 2 on opposite sides of the rope wheel 6.

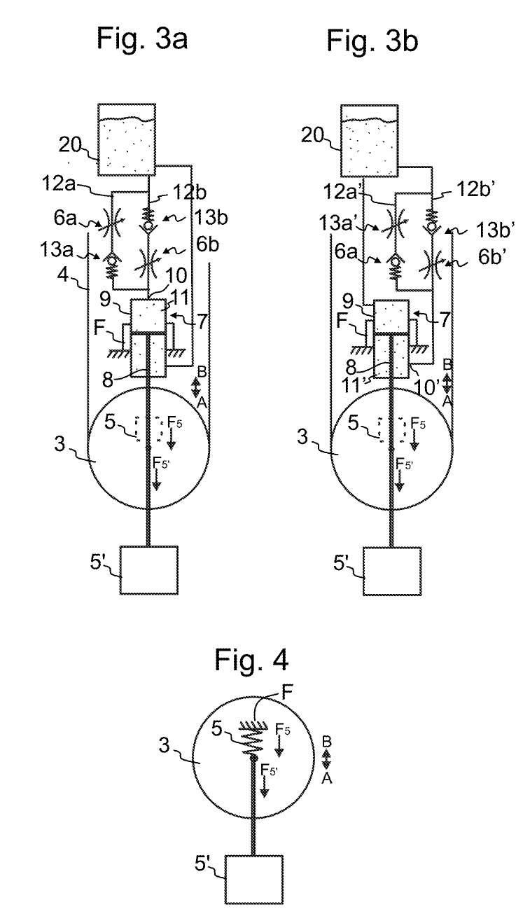

The elevator further comprises at least one tightening wheel 3 located in the lower end of the hoistway H, and a second roping 4 interconnecting the car 1 and counterweight 2 and passing around the at least one tightening wheel 3. The tightening wheel is mounted movably back and forth in a first direction A towards the second roping 4, and in a second direction B away from the second roping 4. Movement in the first direction A tightens the second roping 4 and movement in the second direction loosens the roping. The elevator further comprises means 5, 5′ for exerting a force on the tightening wheel 3 to move it in the first direction A so as to tighten the roping. Said means may be in the form of a spring 5 or a weight 5′ or a combination of these, for example. The elevator further comprises means (F, 6, 7, 10, 12; F, 6′, 7, 10′, 12′; F, 6a, 6b, 7, 10′, 12a, 12b; F, 6a′, 6b′, 7, 12a′, 12b′) for limiting the movement speed of the tightening wheel 3 towards the first direction A and the second direction B, whereby said means (F, 6, 7, 10, 12; F, 6′, 7, 10′, 12′; F, 6a, 6b, 7, 10′, 12a, 12b; F, 6a′, 6b′, 7, 12a′, 12b′) are configured to allow movement of the tightening wheel 3 towards the first direction A with a limited speed as well as to allow movement of the tightening wheel 3 towards the second direction B with a limited speed. Said means thereby limit the movement speed of the tightening wheel 3 towards the first direction A and second direction B without blocking the movement towards these directions totally. FIGS. 2a, 2b, 3a and 3b illustrate preferred embodiments for the means (F, 6, 7, 10, 12; F, 6′, 7, 10′, 12′; F, 6a, 6b, 7, 10′, 12a, 12b; F, 6a′, 6b′, 7, 12a′, 12b′) for limiting the movement speed of the tightening wheel 3 towards the first direction A and the second direction B.

As a consequence of limiting the movement speed of the tightening wheel 3 towards the first direction A, the risks of sudden movement of the car during a loading situation are substantially eliminated. The car normally starts to react to a sudden increase in car load during a loading situation by a downswing. The tension of the second roping 4 decreases due to the car movement, which would normally be right away reacted to by the tightening means. In the preferred embodiment, however, the movement speed of the tightening wheel 3 towards the first direction A is limited, and the tightening wheel 3 is not able to rapidly move towards direction A to tighten the second roping 4. Such a rapid response of the tightening wheel 3 would increase the forces urging the car 1 downwards thereby working for the downswing. Due to this kind of slow response, the tension is not rapidly recovered, but the tension remains at a considerably lower level longer than it would in a system allowing unlimited movement speed for the tightening wheel 3. A substantial part of the effects of the sudden increase in car load can thus be neutralized. Particularly a sudden stepwise sag of the car 1 is thus eliminated. Such a stepwise sag, typically in the range of 0.2 to 1 cm, would be inconvenient for the passengers but could also be harmful for a sensitive objects being transported.

As a consequence of limiting the movement speed of the tightening wheel 3 towards the second direction B, on the other hand, the risks of sudden movement of the car 1 during an unloading situation are substantially eliminated. The car 1 normally starts to react to a sudden decrease in car load during a loading situation by an upswing. The tension of the roping R pulls the lightened car 1 upwards. Movement of the car 1, however, cannot take place unless the second roping 4 is pulled upwards along with the car 1. In the preferred embodiment, the movement speed of the tightening wheel 3 towards the first direction B is limited, whereby the tightening wheel 3 is not able to rapidly move towards direction B to allow the second roping 4 to rapidly allow movement of the car 1 upwards. Due to this kind of slow response, the tension in the second roping 4 is temporarily increased, and the increased tension is maintained considerably longer than it would in a system allowing unlimited movement speed for the tightening wheel 3. A substantial part of the effects of the sudden increase in car load can thus be neutralized. Particularly a sudden stepwise lift of the car 1 is thus eliminated. Such a stepwise lift, typically in the range of 0.2 to 1 cm, would be inconvenient for the passengers but could also be harmful for a sensitive objects being transported.

The slow response in movement towards direction A or B facilitated by said limiting of the speed of the tightening wheel 3 results in that the undesired car movement can be neutralized in both of these directions, but also in that the tightening wheel 3 can move slowly towards either one of the first direction A and second direction B, as optimal for the situation, such that tension in the second roping 4 is maintained appropriate.

In FIGS. 2a, 2b, 3a and 3b preferred embodiments for the means (F, 6, 7, 10, 12; F, 6′, 7, 10′, 12′; F, 6a, 6b, 7, 10′, 12a, 12b; F, 6a′, 6b′, 7, 12a′, 12b′) for limiting the movement speed of the tightening wheel 3 towards the first direction A and the second direction B are shown. Said means for limiting the movement speed of the tightening wheel comprise a frame F mounted in the hoistway H and a hydraulic cylinder 7 containing hydraulic fluid and being mounted between the frame and the tightening wheel 4, one of its piston part 8 and cylinder part 9 being attached to the frame F, and the other of its piston part 8 and cylinder part 9 being attached to the tightening wheel 3. In the embodiment shown, the cylinder part 9 is attached to the tightening wheel 3. The attachment point can be the shaft or shaft supporting frame structure of the tightening wheel 3, for example. Movement of the tightening wheel 3 in said first direction A is configured to cause a stroke of the hydraulic cylinder 7 wherein the piston 8 moves in the cylinder part 9 in a first stroke direction, and movement of the tightening wheel 3 in said second direction B being configured to cause a stroke of the hydraulic cylinder 7 wherein the piston 8 moves in the cylinder part 9 in a second stroke direction. Said means for limiting the movement speed comprise means 6, 10, 12; 6′, 10′, 12′; 6a, 6b, 10′, 12a, 12b; 6a′, 6b′, 12a′, 12b′ for limiting stroke speed of the cylinder 7 in the first and second stroke direction

The means 6, 10, 12; 6′, 10′, 12′; 6a, 6b, 10′, 12a, 12b; 6a′, 6b′, 12a′, 12b′ for limiting stroke speed of the cylinder 7 comprises a conduit system 12;12a, 12b for allowing passage of hydraulic fluid to and from the hydraulic chamber 11;11′ during strokes of the hydraulic cylinder 7 connected with an opening 10 formed in the hydraulic chamber 11;11′, which is sealedly closed space apart from said opening 10;10′. The hydraulic chamber 11;11′ is delimited by the piston part 8 and the cylinder part 9. The means 6, 10, 12; 6′, 10′, 12′; 6a, 6b, 10′, 12a, 12b; 6a′, 6b′, 12a′, 12b′ for limiting stroke speed of the cylinder 7 further comprise one or more adjustable flow control valves 6;6′;6a, 6b;6a′, 6b′ in the conduit system 12;12′;12a, 12b;12a′, 12b′. In each of the stroke in said first direction and the stroke in the second stroke direction the head of the piston part 9 moves relative to the cylinder such that the volume (increase or decrease) of the hydraulic chamber 11 is changed change. Each stroke is arranged to displace an amount of hydraulic fluid through said opening 10 and through at least one of said one or more adjustable flow control valves 6;6′;6a, 6b;6a′, 6b′, which amount is equal to the amount of change of the volume of the hydraulic chamber 11;11′ during the stroke, the flow rate of hydraulic fluid into (during a stroke in one of the first and second stroke direction) and out of (during a stroke in the other of the first and second stroke direction) the hydraulic chamber through said opening 10;10′ being thereby limited by said at least one adjustable flow control valve 6;6;6a, 6b;6a′, 6b′. Thereby the stroke speed of the cylinder 7 during each stroke is adjustably limited. Hereby, the stroke speeds are easy to adjust. The hydraulic system is hereby also simple to implement and service.

In the embodiments of FIGS. 2a and 2b the hydraulic fluid is moved via the same route in the strokes towards first stroke direction and the second stroke direction. The means 6, 10, 12; 6′, 10′, 12′ for limiting stroke speed of the cylinder 7 comprises a conduit system 12:12′ for allowing passage of hydraulic fluid to or from the hydraulic chamber 11;11′ during said stroke of the hydraulic cylinder is connected with an opening 10;10′ in a hydraulic chamber delimited by the piston and the cylinder, and an adjustable flow control valve in the conduit system, and in that each of the stroke in said first stroke direction and the stroke in the second stroke direction is arranged to a change the volume (increase or decrease) of the hydraulic chamber, and to displace an amount of hydraulic fluid through said opening 10;10′ and said adjustable flow control valve, which amount is equal to the amount of change of the volume of the hydraulic chamber during the stroke, the flow rate of hydraulic fluid into the hydraulic chamber (11;11′) during a stroke in one of the first and second stroke direction, and the flow rate of hydraulic fluid out of the hydraulic chamber (11;11′) during a stroke in the other of the first and second stroke direction being thereby limited by said same flow control valve 6;6′. Thereby the stroke speed of the cylinder 7 during each stroke is adjustably limited in a simple fashion.

The embodiments of FIGS. 2a and 2b are alternative to each other and otherwise similar but the hydraulic chamber 11;11′ having the opening 10;10′ wherein the conduit system 12;12′ is connected to are on opposite sides of the piston part 8. In the embodiment of FIG. 2a, the piston draws hydraulic fluid through said conduit system 12 during the stroke in first direction and pushes hydraulic fluid through said conduit system 12, particularly through the adjustable valve 6 during a stroke in second direction. In the embodiment of FIG. 2b, the piston 8 pushes hydraulic fluid through said conduit system 12′ during the stroke in first direction and pushes hydraulic fluid through said conduit system 12′, particularly through the adjustable valve 6′, during a stroke in second direction. In these embodiments, the conduit system 12;12′ is between a hydraulic tank 20 and the opening 10;10′.

In the embodiments of FIGS. 3a and 3b the hydraulic fluid is moved via different routes in the strokes towards first stroke direction and the second stroke direction. In these embodiments, the means 6a, 6b, 10′, 12a, 12b;6a′, 6b′, 12a′, 12b′ for limiting stroke speed of the cylinder 7 comprises a conduit system 12a, 12b;12a′, 12b′ for allowing passage of hydraulic fluid into (during a stroke in one of the first and second stroke direction) and out of (during a stroke in the other of the first and second stroke direction) hydraulic chamber 11;11′. The conduit system 12a, 12b;12a′, 12b′ is connected with an opening 10, 10′ in a hydraulic chamber delimited by the piston 8 and the cylinder 9, and adjustable flow control valves 6a, 6b;6a′, 6b′ in the conduit system 12a, 12b;12a′, 12b′, and in that a stroke in said first stroke direction is arranged to a change the volume (increase or decrease) of the hydraulic chamber, and to displace an amount of hydraulic fluid through said opening 10 and a first adjustable flow control valve 6a;6a′, which amount is equal to the amount of change of the volume of the hydraulic chamber 11;11′ realized during the stroke, and in that a stroke in said second stroke direction is arranged to a change the volume (increase or decrease) of the hydraulic chamber 11;11′, and to displace an amount of hydraulic fluid through said opening 10;10′ and a second adjustable flow control valve 6b;6b′, which amount is equal to the amount of change of the volume of the hydraulic chamber 11;11′ realized during the stroke, the flow rate of hydraulic fluid into (during a stroke in one of the first and second stroke direction) and out from (during a stroke in the other of the first and second stroke direction) the hydraulic chamber through said opening 10;10′ being thereby limited by different adjustable flow control valves 6a, 6b;6a′, 6b′. Thereby the stroke speed of the cylinder in each stroke direction is limited individually adjustably.

More particularly, said means 6a, 6b, 10′, 12a, 12b;6a′, 6b′, 12a′, 12b′ for limiting the stroke speed of said stroke comprise an opening 10, 10′ in the hydraulic chamber 11;11′ of the cylinder 7, which hydraulic chamber 11;11′ is a closed space apart from said opening 10;10′. That is, no other openings lead out from it. Said means further comprise a first conduit 12a;12a′, connected with the opening 10, 10′ for allowing passage of the hydraulic fluid to enter the hydraulic chamber 11, 11′ during a stroke of the hydraulic cylinder 7 in one (in FIG. 3a first stroke direction, down) of the first and second stroke direction, and a second conduit 12b;12b′ connected with the opening 10;10′ for allowing passage of the hydraulic fluid to exit the hydraulic chamber 11;11′ during a stroke in the other (in FIG. 3a second stroke direction, up) of the first and second stroke direction, and in the first conduit 12a;12a′ a one-way valve 13a;13a′ arranged to allow flow through the first conduit 12a, 12a′ into the hydraulic chamber and to block flow in the opposite direction, and a first adjustable flow control valve 6a delimiting the flow rate of hydraulic fluid into the hydraulic chamber 11;11′ during a stroke of the hydraulic cylinder 7 in said one of the first and second stroke direction, and in the second conduit 12b;12b′ a one-way valve 13b;13b′ arranged to allow flow through the second conduit 12b;12b′ from the hydraulic chamber 11, 11′ and to block flow in the opposite direction, and a second adjustable flow control valve 6b;6b′ delimiting the flow rate of the hydraulic fluid away from the hydraulic chamber 11;11′ during a stroke of the hydraulic cylinder 7 in said other of the first and second stroke direction.

The embodiments of FIGS. 3a and 3b are alternative to each other and otherwise similar but their hydraulic chambers 11;11′ having the opening 10;10′ wherein the conduit system 12a, 12b;12a′, 12b′ is connected to are on opposite sides of the piston part 8. In the embodiment of FIG. 3a, the piston draws hydraulic fluid through the branch 12a of said conduit system 12a, 12b, particularly through adjustable valve 6a and the one-way valve 13a, during the stroke in first direction, and the piston part 8 pushes hydraulic fluid through the branch 12b of said conduit system 12a, 12b, particularly through adjustable valve 6b and the one-way valve 13b during the stroke in the second direction. In the embodiment of FIG. 3b, the piston part 8 pushes hydraulic fluid through the branch 12b′ of said conduit system 12a′, 12b′, particularly through adjustable valve 6b′ and the one-way valve 13b′, during the stroke in first direction, and the piston part 8 draws hydraulic fluid through the branch 12a′ of said conduit system 12a′, 12b′, particularly through adjustable valve 6a′ and the one-way valve 13a′ during the stroke in the second direction. In these embodiments, the conduit system 12a, 12b;12a′, 12b′ is between a hydraulic tank 20 and the opening 10;10′.

As illustrated in FIGS. 2a to 4 the elevator comprises means 5, 5′ for exerting a force on the tightening wheel 3 to move it in the first direction A so as to tighten the roping. Said means 5, 5′ for exerting force F₅, F_{5′} on the tightening wheel are arranged to continuously exert said force on the tightening wheel 3, i.e. all the time when the elevator is in use. Said means may comprise a spring 5 or a weight 5′ or comprise both of these, as illustrated. FIG. 4 illustrated further details of the means 5, 5′ for exerting a force on the tightening wheel 3. Said means comprise in this case a spring 5 arranged to continuously urge the tightening wheel 3 towards the first direction A by its spring force F₅. The spring 5 is preferably a compression spring 5 arranged to push the tightening wheel towards tightening direction by its spring force F₅, as illustrated. In this case, it is preferably mounted between the frame F and the diverting wheel 3. Additionally, it is preferable, but not necessary that said means 5, 5′ for exerting force F₅, F_{5′} on the tightening wheel 3 to move the tightening wheel towards tightening direction comprise a weight 5′ arranged to urge the tightening wheel 3 towards the first direction A by its weight F_{5′}, i.e. force generated on the weight 5′ by force of gravity.

The frame F is preferably mounted in the hoistway H immovably relative to the hoistway H. Furthermore, as illustrated, it is preferable that the hydraulic cylinder is mounted between the frame F and the tightening wheel 3 such that one of the piston and cylinder is attached to the frame F immovably relative to the frame F at least in the stroke direction of the cylinder and the other is movable relative to the frame F and attached on the tightening wheel 3, such as on the shaft or shaft supporting frame structure of the tightening wheel 3.

The adjustable flow control valve 6;6′;6a, 6b;6a′, 6b′ particularly has an adjustable flow rate. Preferably, for this purpose it has a flow orifice the size is of which is adjustable. The adjustable flow control valve 6;6′;6a, 6b;6a′, 6b′ may be in the form of a so called adjustable choke valve for instance wherein the flow orifice size is adjustable, for instance a so called needle valve.

It is to be understood that the above description and the accompanying Figures are only intended to illustrate the present invention. It will be apparent to a person skilled in the art that the inventive concept can be implemented in various ways. The invention and its embodiments are not limited to the examples described above but may vary within the scope of the claims.

1. An elevator comprising
a hoistway;
an elevator car vertically movable in the hoistway;
a counterweight vertically movable in the hoistway;
at least one rope wheel located in or at least in proximity of the upper end of the hoistway;
a first roping interconnecting the car and counterweight and passing around the at least one rope wheel located in or at least in proximity of the upper end of the hoistway;
at least one tightening wheel located in the lower end of the hoistway;
a second roping interconnecting the car and counterweight and passing around the at least one tightening wheel, the tightening wheel being mounted movably back and forth in a first direction towards the second roping, and in a second direction away from the second roping; and
means for exerting force on the tightening wheel to move it in the first direction so as to tighten the second roping,
wherein the elevator comprises
means for limiting the movement speed of the tightening wheel towards the first direction and the second direction.

2. An elevator according to claim 1, wherein said means for limiting the movement speed of the tightening wheel towards the first direction and the second direction comprise a frame mounted in the hoistway and a hydraulic cylinder containing hydraulic fluid and being mounted between the frame and the tightening wheel, one of its piston part and cylinder part being attached to the frame, and the other of its piston part and cylinder part being attached to the tightening wheel, movement of the tightening wheel in said first direction being configured to cause a stroke of the hydraulic cylinder wherein the piston moves in the cylinder part in a first stroke direction, and movement of the tightening wheel in said second direction being configured to cause a stroke of the hydraulic cylinder wherein the piston moves in the cylinder part in a second stroke direction, and in that said means for limiting the movement speed comprise means for limiting stroke speed of the cylinder in the first and second stroke direction.

3. An elevator according to claim 2, wherein said means for limiting stroke speed of the cylinder comprises a conduit system connected with an opening in the hydraulic chamber delimited by the piston part and the cylinder part, and one or more adjustable flow control valves in the conduit system, and in that each of the stroke in said first direction and the stroke in the second stroke direction is arranged to a change the volume of the hydraulic chamber, and to displace an amount of hydraulic fluid through said opening and through at least one of said adjustable flow control valves, which amount is equal to the amount of change of the volume of the hydraulic chamber.

4. An elevator according to claim 2, wherein the means for limiting stroke speed of the cylinder comprises a conduit system connected with an opening in the hydraulic chamber delimited by the piston part and the cylinder part, and adjustable flow control valves in the conduit system, and in that a stroke in said first stroke direction is arranged to a change the volume of the hydraulic chamber, and to displace an amount of hydraulic fluid through said opening and a first adjustable flow control valve, which amount is equal to the amount of change of the volume of the hydraulic chamber, and in that a stroke in said second stroke direction is arranged to a change the volume of the hydraulic chamber during the stroke, and to displace an amount of hydraulic fluid through said opening and a second adjustable flow control valve, which amount is equal to the amount of change of the volume of the hydraulic chamber during the stroke, the flow rate of hydraulic fluid into and out from the hydraulic chamber through said opening being thereby limited by different adjustable flow control valves.

5. An elevator according to claim 2, wherein said means for limiting the stroke speed of said stroke comprise
an opening in a hydraulic chamber of the cylinder,
a first conduit, connected with the opening, for allowing passage of the hydraulic fluid to enter the hydraulic chamber during a stroke of the hydraulic cylinder in one of the first and second stroke direction,
a second conduit, connected with the opening, for allowing passage of the hydraulic fluid to exit the hydraulic chamber during a stroke in the other of the first and second stroke direction, and
in the first conduit a one-way valve arranged to allow flow through the first conduit into the hydraulic chamber and to block flow in the opposite direction, and a first adjustable flow control valve delimiting the flow rate of hydraulic fluid into the hydraulic chamber during a stroke of the hydraulic cylinder in said one of the first and second stroke direction, and
in the second conduit a one-way valve arranged to allow flow through the second conduit from the hydraulic chamber and to block flow in the opposite direction, and a second adjustable flow control valve delimiting the flow rate of the hydraulic fluid away from the hydraulic chamber during a stroke of the hydraulic cylinder in said other of the first and second stroke direction.

6. An elevator according to claim 2, wherein said means for limiting stroke speed of the cylinder comprises a conduit system for allowing passage of hydraulic fluid to or from the hydraulic chamber during said stroke of the hydraulic cylinder connected with an opening in a hydraulic chamber delimited by the piston and the cylinder, and an adjustable flow control valve in the conduit system, and in that each of the stroke in said first direction and the stroke in the second stroke direction is arranged to a change the volume of the hydraulic chamber, and to displace an amount of hydraulic fluid through said opening and said adjustable flow control valve, which amount is equal to the amount of change of the volume of the hydraulic chamber during the stroke, the flow rate of hydraulic fluid into the hydraulic chamber during a stroke in one of the first and second stroke direction, and the flow rate of hydraulic fluid out from the hydraulic chamber during a stroke in the other of the first and second stroke direction being thereby limited by said flow control valve.

7. An elevator according to claim 2, wherein said means for limiting the stroke speed of the cylinder comprise
an opening in a hydraulic chamber of the cylinder,
a conduit, connected with the opening, for allowing passage of the hydraulic fluid to enter the hydraulic chamber during a stroke of the hydraulic cylinder in first stroke direction and for allowing passage of the hydraulic fluid to exit the hydraulic chamber during a stroke in the second stroke direction, and
in the conduit an adjustable flow control valve delimiting the flow rate of hydraulic fluid into the hydraulic chamber during a stroke of the hydraulic cylinder in one of the first and second stroke direction, and delimiting the flow rate of the hydraulic fluid away from the hydraulic chamber during a stroke of the hydraulic cylinder in the other of the first and second stroke direction.

8. An elevator according to claim 1, wherein said means for exerting force on the tightening wheel are arranged to continuously exert said force on the tightening wheel.

9. An elevator according to claim 1, wherein said means for exerting a force on the tightening wheel to move the tightening wheel towards tightening direction comprise a weight arranged to urge the tightening wheel towards the first direction by its weight.

10. An elevator according to claim 1, wherein said means for exerting a force on the tightening wheel comprise a spring arranged to continuously urge the tightening wheel towards the first direction by its spring force.

11. An elevator according to claim 10, wherein said spring is a compression spring arranged to push the tightening wheel towards first direction by its spring force.
